(19) United States
(12) Patent Application Publication
(10) Pub. No.: US 2010/0088906 A1
(43) Pub. Date: Apr. 15, 2010

(54) Leveling Rake

(76) Inventor: Terrence Edwards, South Portland, ME (US)

Correspondence Address: BOHAN MATHERS, PO BOX 17707, PORTLAND, ME, 04112-8707, US

(21) Appl. No.: 12/579,959

(22) Filed: Oct. 15, 2009

Related U.S. Application Data
(60) Provisional application No. 61/105,491, filed on Oct. 15, 2008.

(51) Int. Cl. A01D 7/00; G01B 11/00

(52) U.S. Cl. 33/228; 56/400.14

(57) ABSTRACT

A rake for leveling loose particulate matter on a ground surface is described. The rake head is constructed of a series of bars that are mounted in a mounting spar and spaced a fixed distance apart from each other. A rake handle is movably attached to the rake head. The bars may be made of round bar stock or channel stock. The surface of the bar that is in contact with the loose particulate matter that is to be leveled is a smooth continuous surface. Moving the rake head over ground that is covered with loose particulate matter will move the particulate matter around, pushing excess material into recesses and thereby leveling the surface.

### BACKGROUND INFORMATION

1. Field of the Invention

The invention relates to a rake for use in leveling a ground surface that is covered with loose particulate matter, such as sand or loose soil.

2. Description of the Prior Art

A common task for landscapers and people laying paving stones is to level an area covered with gravel or sand. Conventional tools for this task is a conventional rake, which forms a ridged surface, rather than a smooth one.

What is needed therefore is a leveling tool for gravel or sand, that is easy to use and provides a relatively smooth, ridgeless surface.

### BRIEF SUMMARY OF THE INVENTION

The invention is a rake that is particularly well suited for leveling a ground surface that is covered with a loose particulate matter, such as sand or loose soil. The operational end of the rake, i.e., the rake head, is constructed of a plurality of bars that are held in a particular arrangement, and spaced a distance apart from each other. A handle is attached to the rake head via a clevis fastener or other suitable movable fastener that allows the angle of the handle to vary relative to the rake head. The diameter and the length of the bars may vary, depending on the particular intended application or the size of the person operating the rake, but they can be as small as one-inch outer diameter tubes, for example. The size of the bars and the rake head is not a critical feature of the inventive tool. Generally, the bars are arranged parallel to each other, but depending on the intending application, it is within the scope of the invention to provide a rake head configuration, in which the bars are arranged in a different pattern, such as a chevron pattern, or in a curved pattern. The ends of the bars may be inclined upward, to prevent them from digging into the ground surface.

The rake head is moved across the ground surface, in order to even out a loose particulate matter, such as a surface covered with sand, loose soil, small pebbles, or other small particulate matter. The bars allows the rake head to glide easily along the surface, in a pushing or pulling operation. Peaks of particulate matter are pushed by the bars, so that eventually the particulate matter is distributed evenly across the surface that is worked by the rake, without the bars forming a ridged pattern in the material being worked by the rake.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of the rake according to the invention.

FIG. 2 is a top plane view of the rake head.

FIG. 3 is side plane view of the handle bracket.

FIG. 4 is an illustration of the end of the handle that attaches to the handle bracket on the rake head.

FIG. 5 illustrates a second embodiment of the rake head.

FIG. 6 illustrates the rake according to the invention being used with a rotary laser level.

FIG. 7 illustrates assembly of the bars on the curved edge of the assembly spar.

FIG. 8 illustrates the rake according to the invention, constructed with rectangular bars.

FIG. 9 illustrates the bars assembled to a rake head, in a chevron formation.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

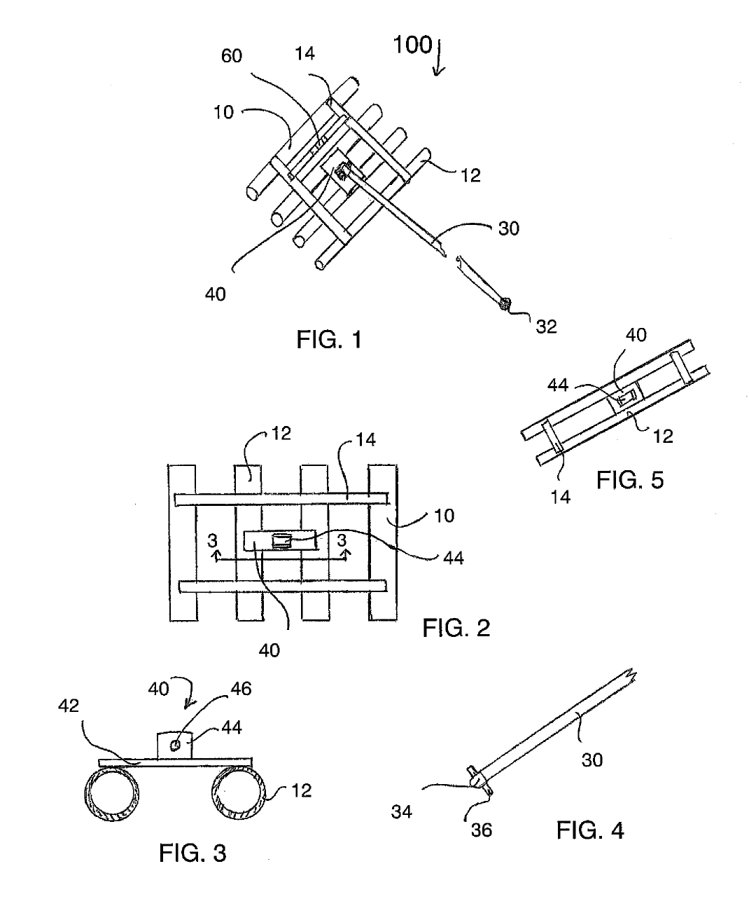

FIG. 1 is a perspective view of a leveling rake 100 for leveling loose matter on a ground surface. The leveling rake 100 comprises a rake head 10, a handle attachment 40, and a handle 30. The rake head 10 is constructed of a series of bars 12, that are fixedly assembled on a rake spar 14, also referred to as an assembly spar or mounting spar. In the embodiment shown in FIGS. 1 and 3, the bars 12 are welded to the rake spar 14 and/or to the handle attachment 40. The bars 12 may be round bars, round hollow tubes, rectangular bars, open channel bars, etc. The surface of the bars 12 that come into contact with the loose matter on the ground is a closed, preferably smooth, surface, but the upper surface of the bars may be open, for reasons of manufacturability, cost, and/or weight reduction. The bars 12 may be straight or curved, the ends of the bars may be inclined upwards, away from the ground surface. The handle attachment 40 is mounted on the rake head 10 and the handle 30 attached to the handle attachment 40. Preferably, the handle attachment 40 provides a movable attachment, so as to allow the angle of the rake handle 30 to be varied relative to the rake head 10 for ease of use.

FIGS. 2 and 5 show top plane views of the rake head 10. A cross-sectional view of the bars 12 is shown in FIG. 3. In this embodiment, the rake head 10 is constructed of round steel tubes that are welded to an assembly spar 14. The bars 12 may be surface treated to prevent corrosion, such as plated, galvanized, anodized, powder coated, painted, etc. They may also be surface treated to facilitate gliding across the ground surface or to prevent wet loose matter from sticking to the rake head. Although the bars are illustrated as steel tubes, it is understood that this is by way of illustration only. The bars 12 may be round rods made of a solid synthetic material, such as graphite, or of wood, or any suitable material. Material other than steel may also be used for hollow tubes, such as aluminum or a metal alloy, If hollow tubes are used as the bars 12, then plugs may be provided on the ends to prevent material from getting into them. The ends of the bars 12 may be inclined upward, in a direction away from the ground surface.

As FIGS. 2 and 5 illustrate, the number and the length of the bars 12 may vary. FIG. 2 shows a rake head 10 that has four bars 12 that are relatively short in length, for example, 29 inches. FIG. 5 shows a rake head 10 that has two bars 12 and is relatively wide, for example, 36 inches. A kit with extensions may be provided, to extend the length of the bars 12. The extensions would fit over the ends of the bars 12 with a friction or interference fit.

FIG. 3 is a side elevational view of the handle attachment 40, which has a bar or a strap 42 that is welded or otherwise fixedly attached to two adjacent tubes 12. A bracket 44 for receiving an end of the handle 30 is mounted on the bar 42. The handle attachment 30 may be constructed as a single component, with the bar 42 and bracket 44 integrated into the single component, or the bracket 44 may be a separate component that is fixedly attached to the bar 42, such as by welding or by a threaded fastener. The bracket shown is a clevis with a hole 46 for receiving a clevis pin 36.

FIG. 4 illustrates the handle fastening means 34 of the handle 30. In the embodiment shown, the handle fastening means 34 is a clevis pin 36, which may be spring-biased, to facilitate insertion into the clevis 44. The handle 30 may be any length that is suitable for operation. It may be fixed in length or be constructed as a telescoping handle to provide adjustability. It may also be removably fastenable to the rake head 10, so as to allow one to replace the handle 30 as necessary. The handle 30 may be constructed of wood, a synthetic material, a metal material. It may also be coated with a rubber or rubber-like coating.

It is understood that the dimensions of the rake 100 are not critical and that the rake 100 may be made to any dimensions that are best suited for the particular intended application. Also, the number of bars or tubes 12 used to construct the rake head 10 may vary. In the embodiment of the rake head 10 shown in FIG. 2, the tubes 12 are 1-inch steel pipe, with one-sixteenth-inch wall thickness, and twenty-nine inches in length. The tubes 12 are spaced approximately three inches apart such that the dimensions of the rake head 10 are 29×10 inches. In the embodiment shown in FIG. 5, the tubes or bars 12 are 36 inches in length. The handle is a wooden pole, 1¼ inch in diameter and 67 inches long. Depending on the preference of the user of the rake 100 of its intended application, recommendations for the length of the handle range between 48 and 80 inches. Also, if lighter materials are used to make the rake head 10 its dimensions in length and width may be increased significantly. The factors determining the most suitable dimensions of the rake head are weight and size. The rake head must remain easy to manipulate, yet be heavy enough to spread out the loose matter.

It is also possible to use the rake head 10 without the handle. For example, the rake head 30 may be suspended from or attached to a towed or powered vehicle, such as a tractor, for the purpose of dragging or pushing it across large tracts of land.

FIGS. 1, 3, and 6 illustrate the bars 12 mounted on the assembly spar 14, such that the bars 12 are parallel to each other and are in a flat plane, when the rake head 10 is brought into its operational position. In other words, when the rake head is pushed across the ground, the operational plane of the bars 12 is flat. FIG. 7 illustrates the bars 12 affixed to an assembly spar 14 that has a curved surface. The spar 14 illustrated has a leading edge 14A and a trailing edge 14D. In this embodiment, the operational plane is curved. This configuration may facilitate the leveling operation, as the approach of the rake head 10 to the material to be leveled is gradual. It is within the scope of the invention to provide a spar 14 having an evenly rounded edge or a straight, slanted edge. In the embodiment shown in FIG. 7, the bars 12 are press-fit into recesses 15 formed in the spar 14, rather than welded to the spar. Other suitable means of attaching the bars 12 to the rake spar 14 or to form the rake head 10 may be used. FIG. 8 illustrates bars 12 that are cut from channel stock, with the assembly spar 14 press fit over the individual bars 12.

FIG. 9 is a schematic illustration of the rake head 10 in which the bars 12 are assembled in a chevron formation.

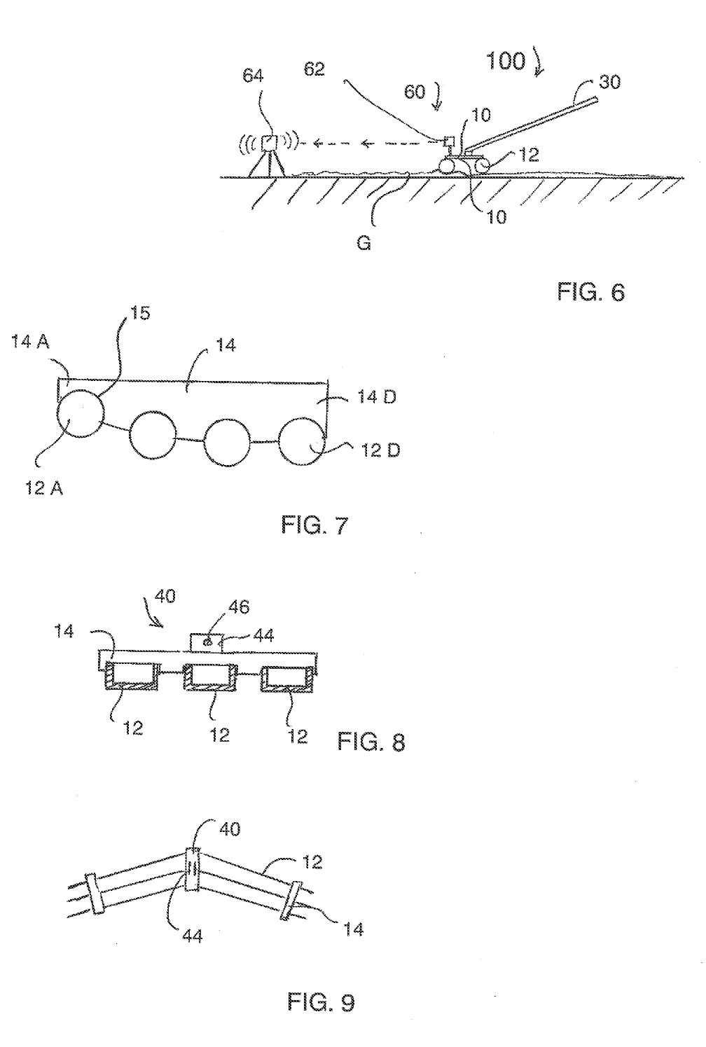

Additional useful devices or instruments may be mounted on the rake head 10, for example, a carpenter's level or a laser level 60, shown in FIG. 1. The level 60 is shown extending in a direction parallel with the bars 12, but it is, of course, understood, that the level 60 can be mounted transverse to the bars 12. FIG. 6 illustrates the rake 100 being used in combination with a conventional rotary laser level 64. The laser level 64 is mounted on a stationary support, such as a tripod, within a sensing distance of the intended use of the rake 100. A signal emitter 62 is mounted on the rake 100. The supports for the rotary laser level 64 and the signal emitter 62 are preferably height adjustable. The height of the laser level is known and the height of the signal emitter is adjusted so as to send a “level” signal to the laser level, when a desired ground surface measurement G is achieved. When the rake 100 is moving over the ground surface at a level that corresponds to the desired ground surface measurement G, the rotary laser level 64 picks up the signal emitted from the signal emitter 62 and sends out an audio signal, as an indication to the operator of the rake 100 that the ground surface has been worked sufficiently to achieve the desired degree of evenness.

It is understood that the embodiments described herein are merely illustrative of the present invention. Variations in the construction of the rake may be contemplated by one skilled in the art without limiting the intended scope of the invention herein disclosed and as defined by the following claims.

What is claimed is:

1: A rake head for leveling loose matter on a ground surface, said rake head comprising:
a plurality of bars fixedly assembled on one or more mounting spars and spaced a distance apart from each other;

2: The rake head of claim 1, wherein the plurality of bars includes at least two round bars.

3: The rake head of claim 1, wherein the plurality of bars includes at least two bars made of channel stock.

4: The rake head of claim 1, wherein the mounting spar has a mounting edge that is flat and wherein the bars are mounted on the flat edge, so as to provide a flat operating plane when the rake head is placed on the ground for leveling the loose matter.

5: The rake head of claim 1, wherein the mounting spar has a mounting edge that is curved and wherein the bars are mounted on the curved edge, so as to provide a curved configuration of bars when the rake head is placed on the ground for leveling loose matter.

6: The rake head of claim 5, wherein the curved edge of the mounting bar has a leading edge and a trailing edge, and wherein the leading edge has a steeper curve than the trailing edge.

7: The rake head of claim 1, further comprising a handle bracket for movably attaching a handle to the rake head, wherein the handle bracket is mounted on one of the one or more mounting spars.

8: A method of leveling loose matter on a ground surface to a desired degree of evenness, said method comprising the steps of:
(a) moving a rake comprising a rake head constructed of a plurality of bars over a ground surface covered with loose particulate material;
(b) providing a laser level at a stationary location;
(c) providing a signal emitter on said rake; and
(d) receiving an audio-signal from said laser level indicating that said ground surface has a desired height that corresponds to a sensor height on said laser level, said audio-signal being emitted when a signal from said signal emitter communicates with a sensor on said laser level.
